(19) United States
(12) Patent Application Publication
(10) Pub. No.: US 2002/0138992 A1
(43) Pub. Date: Oct. 3, 2002

(54) Safety razor with pivot point shift from center to guard-bar under applied load

(76) Inventor: Paul Richard, Shelton, CT (US)

Correspondence Address: Gregg C. Benson, Pfizer Inc., Patent Department, MS 4159, Eastern Point Road, Groton, CT, 06340, US

(21) Appl. No.: 09/820,378

(22) Filed: Mar. 28, 2001

(51) Int. Cl. B26B 21/52

(52) U.S. Cl. 30/527; 30/50

(57) ABSTRACT

A safety razor which features a pivot point that shifts from a center point pivot substantially on the shave plane, to a guard-bar pivot substantially on the shave plane, as shaving forces increase to help prevent nicks and cuts, and provide a smooth shave.

### BACKGROUND OF THE INVENTION

1. Field of the Invention

The invention relates generally to safety razor shaving systems that include razor blade assemblies for mounting on handles via pivotal connections. More particularly, the invention relates to a safety razor which features a pivot point that shifts from a center point pivot (e.g., at the center blade of a triple blade razor, substantially on the shave plane), to a guard-bar pivot, substantially on the shave plane, as shaving forces increase to help prevent nicks and cuts, and provide a smooth shave.

2. Brief Description of the Prior Art

Safety razors are well known that employ blade units with a plurality of blades defining sharpened edges arranged to pass in succession over a skin surface being shaved.

The invention is applicable to safety razors having blade units in the form of cartridges detachably mounted on a handle for replacement when the blade edges have become dulled; and to disposable safety razors having blade unit cartridges, which are permanently attached to a razor handle.

The aforementioned blade unit cartridges (whether permanently affixed to a handle or in the form of a replaceable cartridge), generally comprise a rectangular molded plastic frame with guard and cap surfaces on the lengthwise extending frame parts. Within the opening of the frame the blades are arranged in tandem with their cutting edges parallel to each other and directed towards the guard surface.

It is well known that the so-called shaving geometry of a blade unit is important in determining the shaving performance of the unit. The shaving geometry defines the position and orientation of the blades in relation to other skin contacting parts, in particular the guard and cap of the blade unit.

Well known razor blade assemblies employ spring biased cam followers on razor handles to interact with cam surfaces on the bottoms of razor blade assemblies so as to bias the assemblies to neutral positions relative to the handles.

During shaving, the cartridge assemblies can pivot forward (clockwise) or backward (counterclockwise) from the neutral position relative to the handle, and the blade package can thereby follow the contours of the skin surface during shaving.

Examples of commercially available safety razors that include the aforementioned pivoting feature include the Schick Xtreame III (TM) triple blade convenience razor; the Gillette Sensor Excel (TM) safety razor and Gillette's Mach III (TM) safety razor.

The blade cartridges for both the Schick Xtreame III razor and the Gillette Sensor Excel safety razor, rotate about a center point pivot; and the cartridges may be rotated bi-directionally from their neutral position.

A center pivot balances forces to allow one to shave evenly with all three blades of the aforementioned triple blade razors.

The Gillette Mach III safety razor is an example of a razor that features a guard-bar pivot (pivoting takes place on an axis through the guard-bar as opposed to a center point pivot); with the cartridge being capable of only of unidirectional rotation from its neutral position.

With a guard-bar pivot one obtains a “safer” shave than with a center pivot arrangement since applied loads (e.g., pressing the razor against the skin) are on the guard-bar and NOT the blades. The guard-bar also facilities stretching of the skin compared with a center pivot system, thereby promoting a safe close shave.

During shaving the blades of a blade unit are subjected to a combination of drag forces and the load forces mentioned hereinbefore. Drag forces are those directed essentially parallel to the shaving plane, and load forces are those forces directed against the blade by the skin in the direction substantially perpendicular to the shaving plane (as hereinbefore indicated happens when the razor is pressed in toward the face).

Generally speaking it is important to locate the pivot point of a razor as close to the shave plane as possible to minimize the over-turning moment due to drag force.

Additionally, by applying the razor against the skin surface under greater load pressure to seek an improved closeness of shave, it is desirable to on one hand utilize all the blades in the razor as uniformly as possible (e.g., to prevent dulling of a particular blade, to achieve the maximum cutting action in a single stroke, etc.); yet achieve and maintain a safe shave so that increasingly applied loads do not cause nicks and cuts. Generally, as the force of shaving (loading) increases, the likelihood of experiencing a nick or a cut increases.

Stated another way, it is desirable to accommodate varying loads by the user during the shaving process, minimize drag, insure a close shave and at the same time assure a safe shave.

Although the prior art systems referred to hereinabove employ pivot mechanisms to achieve maximum shaving performance and safety (with tradeoffs of course depending on the type of pivot system used), the pivot axis in all the known systems remain substantially the same.

This has the effect, for center point pivot systems, of not taking maximum advantage of the skin stretching and protection features of the guard-bar which limit blade exposure and protect against nicks and cuts; while for guard-bar pivot systems, do not taking maximum advantage of the multiple blades available in light loading situations where receiving nicks and cuts are far less likely (the aforementioned “tradeoffs”).

Accordingly, it would be desirable to be able to increase loading on the razor and yet maintain a safe shave in pivoting razor systems by shifting the pivot point from the center to the guard-bar under heavy load.

It would also be desirable to provide a razor, which pivots about the center for an even shave under light loading but pivots about the guard-bar under heavy loading.

It would be desirable to provide a razor, which accommodates varying loads by a user during the shaving process, minimizes drag, insures a close shave and at the same time assures a safe shave.

It would also be desirable to provide a razor which utilizes all the blades in the razor as uniformly as possible to prevent dulling of a particular blade, which achieves the maximum cutting action in a single stroke, etc.; and at the same time achieves and maintains a safe shave so that increasingly applied loads do not cause nicks and cuts.

### SUMMARY OF THE INVENTION

It is a general object of the invention to be able to increase loading on a pivot type razor while maintaining a safe shave.

It is a specific object of the invention to accommodate varying loads by a user during the shaving process, minimize drag, insure a close shave and at the same time assure a safe shave.

It is a further object of the invention to be able to utilize all the blades in the razor as uniformly as possible to prevent dulling of a particular blade, to achieve the maximum cutting action in a single stroke, etc.; and at the same time achieve and maintain a safe shave so that increasingly applied loads do not cause nicks and cuts.

It is yet another object of the invention to provide a razor which pivots about the center of the blade assembly under light loading but which pivots about the guard-bar under heavy loading.

In accord with these objects, which will be discussed in detail below, the razor according to the present invention includes a blade assembly (or cartridge), a pivot assembly, and a pivot frame. The blade assembly is pivotally coupled to the pivot assembly and the pivot assembly is pivotally coupled to the pivot frame.

A first biasing member between the blade assembly and the pivot assembly biases the blade assembly to a first position. A second biasing member between the pivot assembly and the pivot frame biases the pivot frame to a neutral position. The first biasing member is preferably stronger than the second biasing member.

When the blade assembly is in the first position, application of loading to the blade assembly will cause the blade assembly and the pivot to rotate about the center line of the blade assembly. Upon the application of additional load, the blade assembly will be moved against the first biasing member and will move to a second position relative to the pivot assembly. When the blade assembly is in the second position, application of loading to the blade assembly will cause the blade assembly and the pivot assembly to rotate about the guard-bar of the blade assembly.

According to one embodiment of the invention, the pivot assembly is bi-directionally pivotable relative to the pivot frame and is free to pivot approximately ±200.

According to another embodiment of the invention, the pivot assembly is uni-directionally pivotable relative to the pivot frame and is free to pivot approximately 40°.

The pivotal coupling between the blade assembly and the pivot assembly is preferably effected with a pair of bosses on the pivot assembly and a mating pair of pivot pockets on the blade assembly. The bosses are approximately 180° semicircular and the pockets are approximately 225° thereby allowing the blade assembly to pivot approximately 45° relative to the pivot assembly. The pivotal coupling between the pivot assembly and the pivot frame is preferably accomplished via a pair of female journals on the pivot assembly, which are engaged by a corresponding male journals on the pivot frame. The second biasing member is preferably embodied as a bendable finger, which extends between the male journals and engages a central portion of the pivot assembly.

In the bi-directional embodiment, the bendable finger engages a pair of downwardly extending U-shaped members. In the unidirectional embodiment, the bendable finger has a cam follower, which engages a cam surface on one side of the pivot assembly.

### BRIEF DESCRIPTION OF THE DRAWINGS

FIG. 1 is a front perspective view of an exemplary triple blade cartridge suitable for use in accordance with the teachings of the invention.

FIG. 2 is a rear perspective view of the exemplary cartridge depicted in FIG. 1

FIG. 3 is a front perspective view of an exemplary pivot that in accord with the teachings of the invention cooperates with the cartridge shown FIGS. 1 & 2.

FIG. 4 is a front perspective view of an exemplary bi-directional pivot frame contemplated by the invention.

FIG. 5 is a front perspective view of an exemplary unidirectional pivot frame contemplated by the invention.

FIG. 6 is a front perspective view of the exemplary cartridge and pivot of FIGS. 1-3 mounted on the exemplary bi-directional pivot frame shown in FIG. 4, to form a bi-directional shaving system of the type contemplated by the invention.

FIG. 7 illustrates a side sectional view of the shaving system of FIG. 6 with the blade assembly biased to the first position.

FIG. 8 illustrates a side sectional view of the shaving system of FIG. 6 with the blade assembly under loading pivoted to the second position.

FIGS. 9-11 are similar to FIGS. 6-8 but illustrate the unidirectional embodiment.

### DETAILED DESCRIPTION

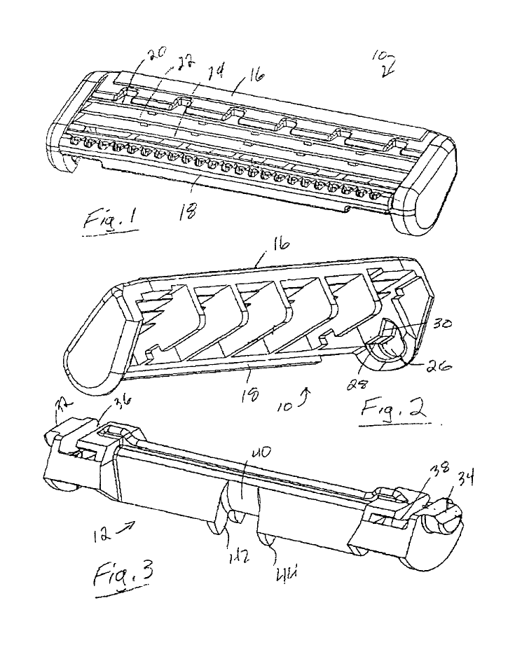

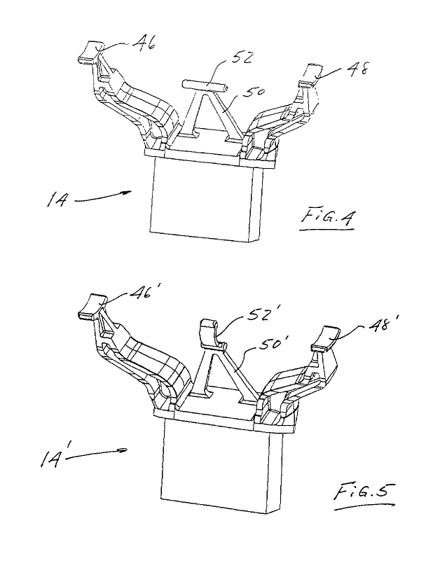

Turning now to FIGS. 1-5, an exemplary razor assembly according to the invention includes a blade assembly (or cartridge) 10, a pivot assembly 12, and a pivot frame 14, 14′. The blade assembly 10 includes a cap 16, a guard-bar 18, and a plurality of blades 20, 22, 24 arranged between the cap and the guard-bar. The lower interior of the blade assembly 10 includes a pair of sockets 26, one of which can be seen in FIG. 2. The sockets have a pair of stops, 28, 30 which are approximately 225° apart.

The pivot assembly 12 has a pair of bosses, 32, 34 which are dimensioned to engage the sockets 26. The bosses are approximately 180° semi-circular. Thus, rotation from stop 28 to stop 30 is approximately 45°. Adjacent the bosses, the pivot assembly has a pair of female journals 36, 38. Centrally, the pivot assembly has a cam surface 40 and a pair of downward extending U-shaped members 42, 44.

According to a first embodiment of the invention, components 10 and 12 are mated to each other and to the pivot frame 14. According to a second embodiment of the invention, the components 10 and 12 are mated to each other and to the pivot frame 14′.

The pivot frame 14 has a pair of male journals 46, 48 which are located and dimensioned to engage the female journals 36, 38 of the pivot assembly 12. A cantilevered biasing member 50 is located between the male journals. The biasing member 50 includes an axle 52 which is located and dimensioned to engage the downward extending U-shaped members 42, 44 of the pivot assembly 12.

The pivot frame 14′ has a pair of male journals 46′, 48′ which are located and dimensioned to engage the female journals 36, 38 of the pivot assembly 12. A cantilevered biasing member 50′ is located between the male journals. The biasing member 50′ includes a cam follower 52, which is located and dimensioned to engage the cam surface 40 of the pivot assembly 12.

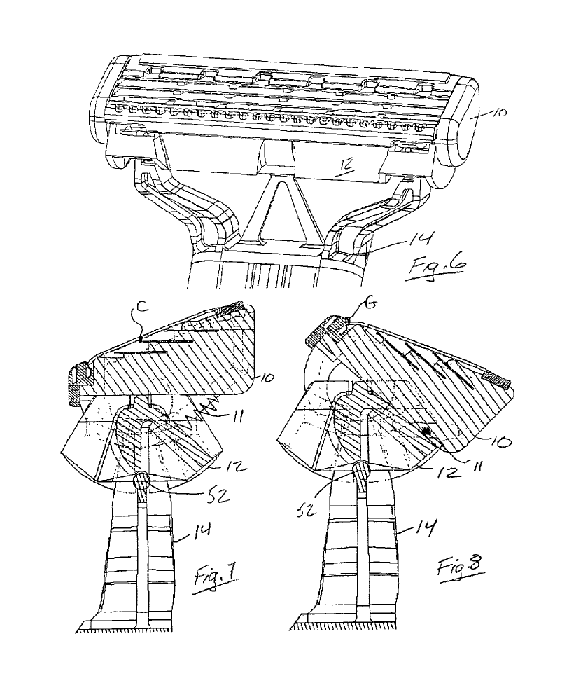

FIGS. 6-8 illustrate the first embodiment assembled. As seen best in FIG. 7, a biasing spring 11 is located between the blade assembly 10 and the pivot assembly 12. The spring 11 biases the blade assembly to the position shown in FIG. 7. As seen in FIG. 7, when the blade assembly is in this first position, application of loading to the blade assembly will cause the blade assembly 10 and the pivot assembly 12 to rotate about the center line “C” ofthe blade assembly. Upon the application of additional load, the blade assembly 10 will be moved against the spring 11 and will move to a second position relative to the pivot assembly 12. FIG. 8 illustrates the second position. When the blade assembly is in the second position, application of loading to the blade assembly will cause the blade assembly and the pivot assembly to rotate about the guard-bar axis “G”. From the foregoing, those skilled in the art will appreciate that the pivot assembly 12 illustrated in FIGS. 6-8 is free to pivot relative to the pivot frame approximately ±20° from the position shown in FIG. 7. Further, it will be appreciated that the blade assembly is free to pivot relative to the pivot assembly approximately 45° from the position shown in FIG. 7 to the position shown in FIG. 8.

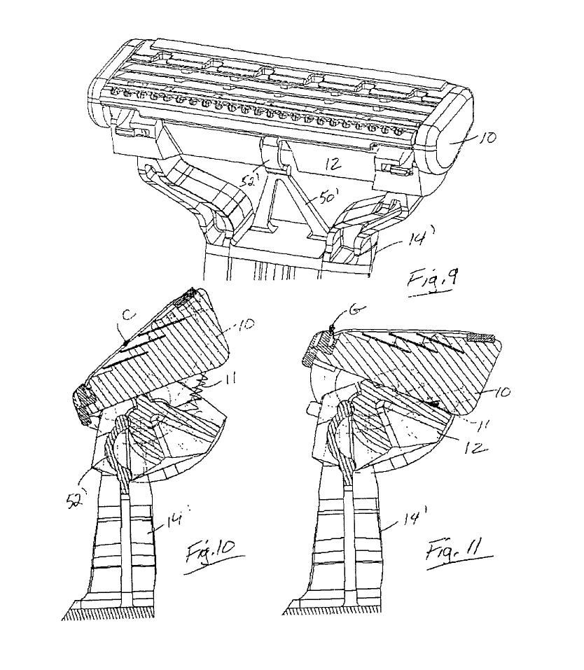

FIGS. 9-11 are similar to FIGS. 6-8 but illustrate a second embodiment of the invention utilizing the pivot frame 14′. Those skilled in the art will appreciate that the pivot assembly 12 illustrated in FIGS. 9-11 is free to pivot relative to the pivot frame approximately 40° from the center position to the position shown in FIGS. 10 and 11. Further, it will be appreciated that the blade assembly is free to pivot relative to the pivot assembly approximately 45° from the position shown in FIG. 10 to the position shown in FIG. 11.

As described above, the invention increases safety by shifting the pivot point from a center point pivot (i.e., at the center blade on the shave plane), to a guard-bar pivot on the shave plane as shaving forces increase. The cartridge rotates relative to the pivot going from a center pivot to a guard-bar pivot. It is returned to its initial position by the spring between the cartridge and the pivot. The cartridge and pivot also move relative to the pivot frame.

Those skilled in the art will appreciate that the pivot frame 14, 14′ could be an integral part of the handle of a razor or could snap into the handle of a razor. It will be appreciated that the frame translates loads from the shavers hand to the cartridge (at either mid-blade or guard-bar positions) via the above-described pivoting motion.

There have been described and illustrated herein several embodiments of an improved safety razor. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

What is claimed is:

1. A shaving system, comprising:
a) a pivot frame;
b) a pivot assembly pivotally coupled to said pivot frame; and
c) a blade assembly pivotally coupled to said pivot assembly.

2. A shaving system according to claim 1, wherein said blade assembly is rotatable relative to said pivot assembly from a first position to a second position and when in said first position, rotation of said pivot assembly relative to said pivot frame causes rotation of said blade assembly about a center axis of said blade assembly.

3. A shaving system according to claim 2, wherein for said blade assembly is rotatable relative to said pivot assembly from a first position to a second position and when in said second position, rotation of said pivot assembly relative to said pivot frame causes rotation of said blade assembly about a guard-bar axis of said blade assembly.

4. A shaving system according to claim 1, further comprising:
d) first biasing means between said blade assembly and said pivot assembly; and
e) second biasing means between said pivot assembly and said pivot frame.

5. A shaving system according to claim 4, wherein said first biasing means is stronger than said second biasing means.

6. A shaving system according to claim 4, wherein said second biasing means allows bi-directional rotation of said pivot assembly relative to said pivot frame.

7. A shaving system according to claim 4, wherein said second biasing means allows only unidirectional rotation of said pivot assembly relative to said pivot frame.

8. A shaving system according to claim 4, wherein said second biasing means is a cantilevered spring.

9. A shaving system according to claim 4, wherein said second biasing member is a cam follower.

10. A shaving system according to claim 1, wherein said blade assembly is rotatable approximately 45° relative to said pivot assembly.

11. A shaving system according to claim 10, wherein said pivot assembly is rotatable approximately ±20° relative to said pivot frame.

12. A shaving system according to claim 10, wherein said pivot assembly is rotatable approximately 40° relative to said pivot frame.

13. A shaving system, comprising:
a) a shaving cartridge that rotates relative to a pivot;
b) a pivot that rotates relative to a pivot frame; and
c) a pivot frame.

14. A shaving system as set forth in claim 13, wherein said shaving cartridge rotates relative to a pivot going from a center pivot to a guard-bar pivot.

15. A shaving system as set forth in claim 13, wherein said shaving cartridge rotates relative to a pivot going from a center pivot substantially on said shave plane to a guard-bar pivot substantially on said shave plane.

16. A shaving system as set forth in claim 13, wherein said shaving cartridge rotates relative to a pivot going from a center pivot substantially on said shave plane to a guard-bar pivot substantially on said shave plane as loading increases.

17. A shaving system as set forth in claim 16, wherein said shaving cartridge rotates relative to said pivot going back from a guard-bar pivot substantially on said shave plane to a center pivot substantially on said shave plane as loading decreases.

18. A shaving system as set forth in claim 17, wherein said pivot relative to said pivot frame supports unidirectional pivoting.

19. A shaving system as set forth in claim 17, wherein said pivot relative to said pivot frame supports bi-directional pivoting.

20. A triple blade shaving system, comprising:
a) a pivot frame;
b) a pivot assembly pivotally coupled to said pivot frame; and
c) a triple blade, blade assembly pivotally coupled to said pivot assembly,
wherein said blade assembly is rotatable relative to said pivot assembly from a first position to a second position; and (1) when in said first position, rotation of said pivot assembly relative to said pivot frame causes rotation of said blade assembly about a center axis, substantially on the shave plane, of said blade assembly; and (2) when in said second position, rotation of said pivot assembly relative to said pivot frame causes rotation of said blade assembly, substantially on said shave plane, about a guard-bar axis of said blade assembly.
